(19) United States
(12) Patent Application Publication
(10) Pub. No.: US 2025/0242264 A1
(43) Pub. Date: Jul. 31, 2025

(54) STORAGE MEDIUM, GAME SYSTEM, GAME APPARATUS, AND GAME PROCESSING METHOD

(71) Applicant: NINTENDO CO., LTD., Kyoto (JP)

(72) Inventor: Tatsuya KURIHARA, Kyoto (JP)

(21) Appl. No.: 19/005,986

(22) Filed: Dec. 30, 2024

(30) Foreign Application Priority Data
Jan. 30, 2024 (JP) 2024-011589

(51) Int. Cl. A63F 13/69; A63F 13/52

(52) U.S. Cl. CPC A63F 13/69; A63F 13/52

(57) ABSTRACT

Voxel data is updated based on a player's operation input such that the voxel data indicates the absence of a terrain for at least a portion of voxels included in a first range set based on a location of the occurrence of an event with respect to the terrain. When in a second range including at least the first range, present is a separate small region that includes contiguous voxels having voxel data indicating the presence of the terrain and has a size smaller than a reference, the voxel data of the voxels included in the small region is updated such that the voxel data of the voxels included in the small region indicates the absence of the terrain.

### CROSS REFERENCE TO RELATED APPLICATIONS

This application claims priority to Japanese Patent Application No. 2024-011589, filed on Jan. 30, 2024, the entire contents of which are incorporated herein by reference.

### FIELD

The technology disclosed herein relates to storage media, game systems, game apparatuses, and game processing methods that are capable of executing a process of generating an image using voxel data.

### BACKGROUND AND SUMMARY

There is a conventional image generation system that displays a game image by creating character voxels based on imaging information and generating polygon mesh information.

However, in such an image generation system, voxels are used in a game in order to use imaging information, and an object or the like generated from the voxels is not supposed to be freely broken. Here, if an object or the like generated from the voxels is supposed to be freely broken, the small pieces (debris) of the broken object may be left, in which case appearance after the destruction deteriorates, and it takes time and effort for a user to remove the broken pieces.

With the above in mind, the present example discloses a storage medium, game system, game apparatus, and game processing method that are capable of preventing small broken pieces from being left after an object is deformed, e.g., broken, in a game using voxels, and thereby attaining deformation having a high degree of freedom with high operability.

The present example may have the following features, for example.

An example configuration of a non-transitory computer-readable storage medium having stored therein a game program according to the present example is executed by one or more processors of an information processing apparatus. The game program causes the one or more processors to execute information processing comprising: storing, in a storage medium, terrain volume data representing a terrain in a virtual space and holding voxel data indicating the presence of the terrain for each voxel included in a voxel space set in the virtual space; when an event occurs with respect to the terrain, based on a player's operation input, updating the voxel data such that the voxel data indicates the absence of the terrain for at least a portion of voxels included in a first range set based on a location of the occurrence of the event, with respect to the terrain volume data, and when in a second range including at least the first range, present is a separate small region that includes contiguous voxels having voxel data indicating the presence of the terrain and has a size smaller than a reference, updating the voxel data of the voxels included in the small region such that the voxel data of the voxels included in the small region indicates the absence of the terrain; and generating an image of the virtual space by rendering at least a polygon mesh representing a surface of the terrain, based on the terrain volume data.

Thus, by causing an event to occur with respect to a terrain formed of voxels, based on a player's operation input, the terrain can be deformed. By preventing broken pieces of the terrain produced by the deformation of the terrain from being left, deformation having a high degree of freedom can be attained with high operability.

The voxel data may be a value indicating a degree to which a space defined by a voxel is occupied by the terrain. The information processing may further comprise: when the event occurs, updating the voxel data such that the voxel data indicates a decrease in the degree in the voxels included in the first range, and the absence of the terrain in at least a portion of the voxels included in the first range.

Thus, the state of a voxel can be easily changed to the state in which no terrain is present, depending on the value indicating the degree.

A region having contiguous voxels having voxel data indicating the presence of the terrain may be determined to be the small region when the sum of values indicating the degrees in the voxels in the region is smaller than a threshold.

Thus, broken pieces having a size less than the size of a voxel can be prevented from being left.

In the first range, a distance from a reference location set based on a location of the occurrence of the event in the virtual space may be within a first distance. The information processing may further comprise: when the event occurs, updating the voxel data such that the voxel data indicates a decrease in the degree according to the distance from the reference location, and the absence of the terrain for voxels within a second distance from the reference location shorter than the first distance.

Thus, a terrain closer to the reference location set based on the location of the occurrence of an event can be deformed to a greater extent.

The voxel data may further include material data indicating a material for the terrain. The information processing may further comprise: when the event occurs, updating the voxel data of the voxels included in the first range such that the decrease in the degree is additionally based on the type of a material for the voxel indicated by the material data.

Thus, variation of deformation of a terrain due to the occurrence of an event can be increased by properties of the terrain.

The information processing may further comprise: generating the polygon mesh according to an algorithm that determines a location of a vertex of a polygon between a voxel in which the terrain is absent and a voxel in which the terrain is present, based on the voxel data; and recalculating vertices of the polygon mesh in a range including at least a voxel whose voxel data has been updated, based on the occurrence of the event.

Thus, processing load can be reduced by limiting recalculation of vertices of a polygon mesh to a range including voxels whose voxel data has been updated. Even when a small region is produced due to such recalculation of vertices of a polygon mesh, the small region, which is a broken piece, can be removed.

The information processing may further comprise: causing a player character to perform an action of breaking the terrain, based on the player's operation input. In the event, the player character's breaking action may hit the terrain.

Thus, the process of deforming a terrain based on the player character's breaking action and the process of removing broken pieces produced by the deformation are provided, thereby preventing the user from feeling unnatural.

The information processing may further comprise: updating the voxel data of the voxels included in the small region such that the voxel data indicates the absence of the terrain, when the small region is in the air in the virtual space.

Thus, broken pieces that are left in the air due to deformation of a terrain when an event occurs can be removed.

The present example may be carried out in the form of a game system, game apparatus, and game processing method.

According to the present example, by causing an event to occur with respect to a terrain formed of voxels, based on a player's operation input, the terrain can be deformed. By preventing broken pieces of the terrain produced by the deformation of the terrain from being left, deformation having a high degree of freedom can be attained with high operability.

These and other features, aspects and advantages of the subject matter described herein will become more apparent from the following detailed description of the present embodiment when taken in conjunction with the accompanying drawings.

### BRIEF DESCRIPTION OF THE DRAWINGS

FIG. 1 is a diagram illustrating a non-limiting example of a state where a left controller 3 and a right controller 4 are attached to a main body apparatus 2,

FIG. 2 is a diagram illustrating a non-limiting example of a state where a left controller 3 and a right controller 4 are detached from a main body apparatus 2,

FIG. 3 illustrates six orthogonal views of a non-limiting example of a main body apparatus 2,

FIG. 4 illustrates six orthogonal views of a non-limiting example of a left controller 3,

FIG. 5 illustrates six orthogonal views of a non-limiting example of a right controller 4,

FIG. 6 is a block diagram illustrating a non-limiting example of an internal configuration of a main body apparatus 2,

FIG. 7 is a block diagram illustrating non-limiting examples of internal configurations of a main body apparatus 2, a left controller 3, and a right controller 4,

FIG. 8 is a view showing a non-limiting example of a terrain object, which is a voxel object,

FIG. 9 is a view showing a non-limiting example before removal of a portion of the terrain object shown in FIG. 8,

FIG. 10 is a view showing a non-limiting example after removal of a portion of the terrain object shown in FIG. 8,

FIG. 11 is a diagram showing a non-limiting example of content of voxel data,

FIG. 12 is a diagram showing a non-limiting example of property information representing properties of materials,

FIG. 13 is a diagram showing a non-limiting example of texture information representing textures of materials,

FIG. 14 is a diagram showing a non-limiting example of a method for generating a mesh,

FIG. 15 is a diagram showing a non-limiting example of a game image including a terrain object,

FIG. 16 is a diagram showing a non-limiting example of a game image in which a player character PC performs an action of breaking a terrain object TO displayed on a display 12,

FIG. 17 is a diagram showing a non-limiting example of a game image in which a player character PC has broken a terrain object TO,

FIG. 18 is a diagram showing a non-limiting example of a game image in which broken pieces produced by a player character PC breaking a terrain object TO have been removed,

FIG. 19 is a diagram showing a non-limiting example of a destruction range of voxels to be broken in a terrain object TO, and a broken piece determination range of voxels for determining broken pieces of the terrain object TO,

FIG. 20 is a diagram showing a non-limiting example of various kinds of data used in an information process executed in a game system 1, and

FIG. 21 is a flowchart showing a non-limiting example of a flow of a game process that is executed in a game system 1.

### DETAILED DESCRIPTION OF NON-LIMITING EXAMPLE EMBODIMENTS

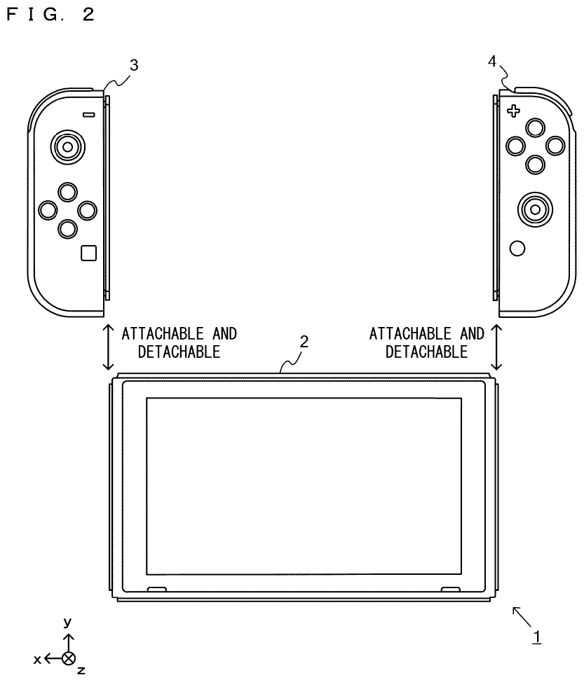

A game system according to the present embodiment will now be described. A non-limiting example of a game system 1 according to the present embodiment includes a main body apparatus (information processing apparatus serving as the main body of a game apparatus in the present embodiment) 2, a left controller 3, and a right controller 4. The left controller 3 and the right controller 4 are attachable to and detachable from the main body apparatus 2. That is, the user can attach the left controller 3 and the right controller 4 to the main body apparatus 2, and use them as a unified apparatus. The user can also use the main body apparatus 2 and the left controller 3 and the right controller 4 separately from each other (see FIG. 2). In the description that follows, a hardware configuration of the game system 1 of the present embodiment is described, and thereafter, the control of the game system 1 of the present embodiment is described.

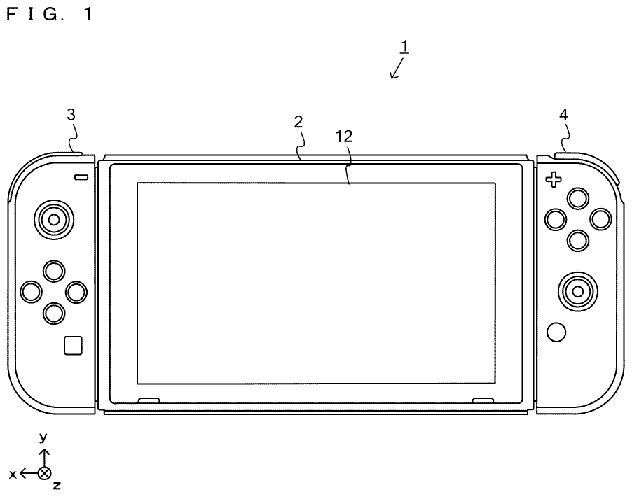

FIG. 1 is a diagram illustrating a non-limiting example of the state where the left controller 3 and the right controller 4 are attached to the main body apparatus 2. As illustrated in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram illustrating a non-limiting example of the state where each of the left controller 3 and the right controller 4 is detached from the main body apparatus 2. As illustrated in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

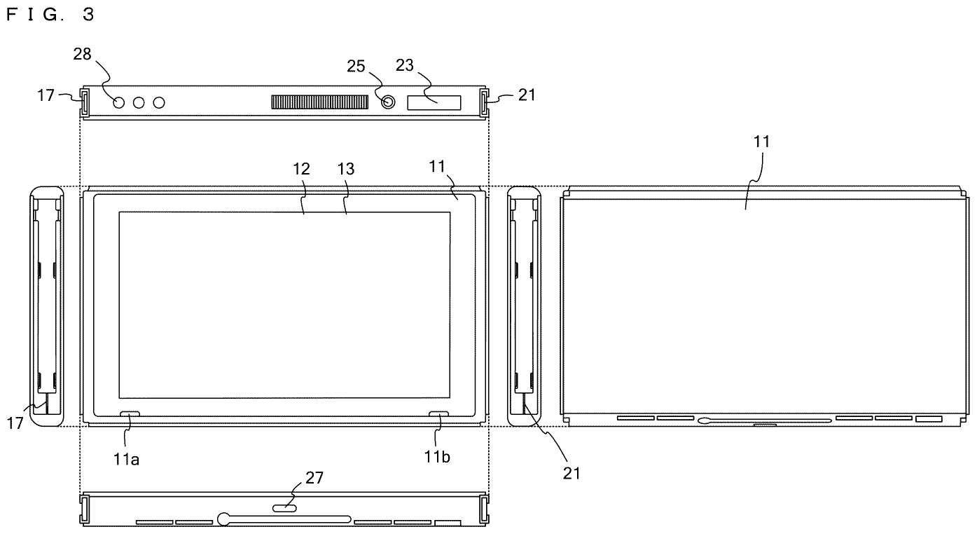

FIG. 3 illustrates six orthogonal views of a non-limiting example of the main body apparatus 2. As illustrated in FIG. 3, the main body apparatus 2 includes an approximately plate-shaped housing 11. In the present embodiment, a main surface (e.g., a surface on a front side, such as a surface on which the display 12 is provided) of the housing 11 has a generally rectangular shape.

It should be noted that the shape and the size of the housing 11 are optional. As a non-limiting example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As illustrated in FIG. 3, the main body apparatus 2 includes the display 12, which is provided on the main surface of the housing 11. The display 12 displays an image generated by the main body apparatus 2. In the present embodiment, the display 12 is a liquid crystal display device (LCD). The display 12, however, may be a display device of any suitable type.

In addition, the main body apparatus 2 includes a touch panel 13 on the screen of the display 12. In the present embodiment, the touch panel 13 allows multi-touch input (e.g., a capacitive touch panel). It should be noted that the touch panel 13 may be of any suitable type, e.g., it allows single-touch input (e.g., a resistive touch panel).

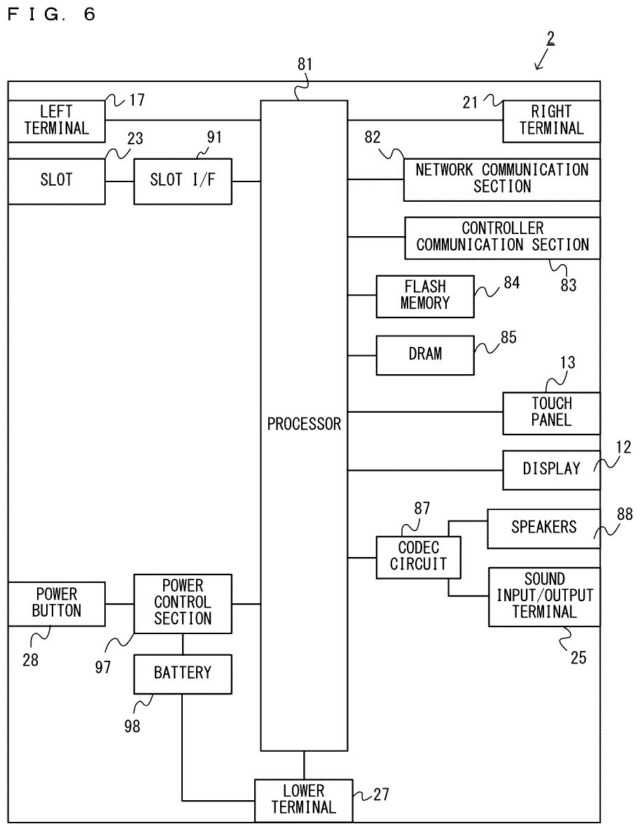

The main body apparatus 2 includes a speaker (e.g., a speaker 88 illustrated in FIG. 6) inside the housing 11. As illustrated in FIG. 3, speaker holes 11a and 11b are formed in the main surface of the housing 11. The speaker 88 outputs sounds through the speaker holes 11a and 11b.

The main body apparatus 2 also includes a left-side terminal 17 that enables wired communication between the main body apparatus 2 and the left controller 3, and a right-side terminal 21 that enables wired communication between the main body apparatus 2 and the right controller 4.

As illustrated in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower-side terminal 27. The lower-side terminal 27 allows the main body apparatus 2 to communicate with a cradle. In the present embodiment, the lower-side terminal 27 is a USB connector (more specifically, a female connector). When the unified apparatus or the main body apparatus 2 alone is placed on the cradle, the game system 1 can display, on a monitor, an image that is generated and output by the main body apparatus 2. The monitor may be stationary or may be movable. Also, in the present embodiment, the cradle has the function of charging the unified apparatus or the main body apparatus 2 alone, being placed thereon. The cradle also functions as a hub device (specifically, a USB hub).

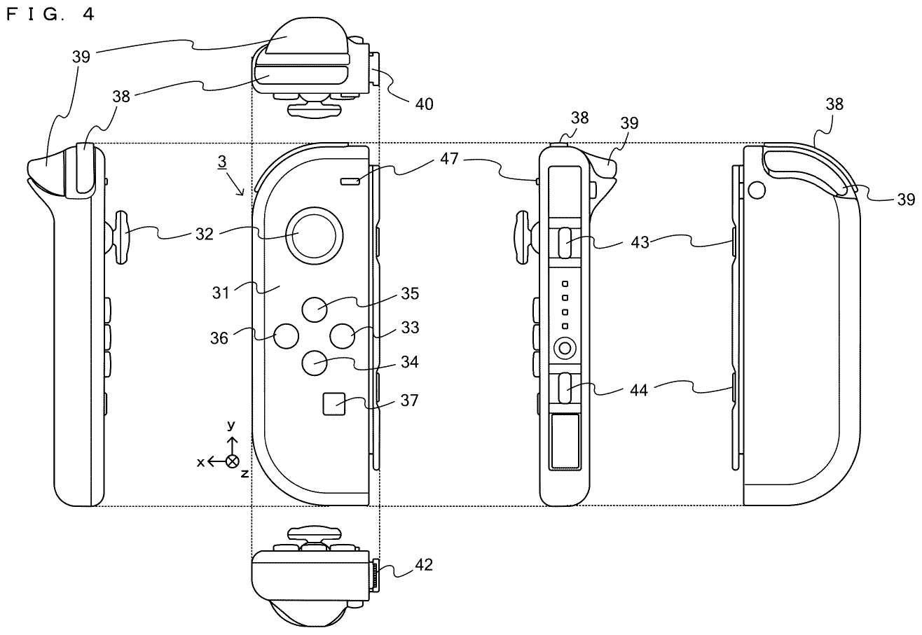

FIG. 4 illustrates six orthogonal views of a non-limiting example of the left controller 3. As illustrated in FIG. 4, the left controller 3 includes a housing 31. In the present embodiment, the housing 31 has a vertically long shape. The housing 31 may be shaped to be long in an up-down direction, e.g., along the y-axis direction illustrated in FIGS. 1 and 4. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As illustrated in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the present embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an operating system (OS) program and an application program) executed by the main body apparatus 2.

The left controller 3 also includes a terminal 42 that enables wired communication between the left controller 3 and the main body apparatus 2.

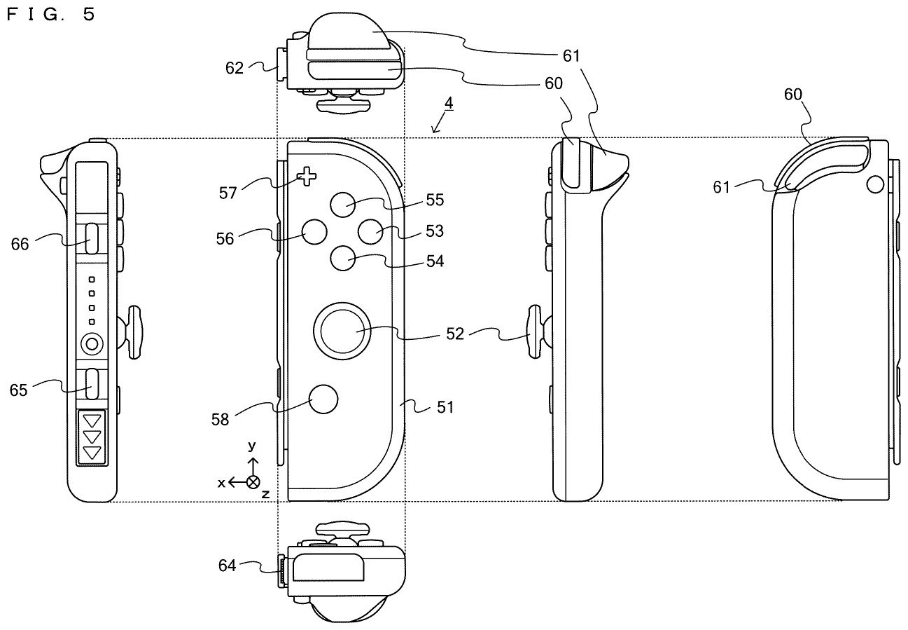

FIG. 5 illustrates six orthogonal views of a non-limiting example of the right controller 4. As illustrated in FIG. 5, the right controller 4 includes a housing 51. In the present embodiment, the housing 51 has a vertically long shape. For example, the housing 51 may be shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the present embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for allowing the right controller 4 to perform wired communication with the main body apparatus 2.

FIG. 6 is a block diagram illustrating a non-limiting example of an internal configuration of the main body apparatus 2. The main body apparatus 2 includes components 81 to 91, 97, and 98 illustrated in FIG. 6 in addition to the components illustrated in FIG. 3. Some of the components 81 to 91, 97, and 98 may be implemented as electronic parts on an electronic circuit board, which is contained in the housing 11.

The main body apparatus 2 includes a processor 81. The processor 81 is an information processor for executing various types of information processing to be executed by the main body apparatus 2. For example, the CPU 81 may include only a central processing unit (CPU), or may be a system-on-a-chip (SoC) having a plurality of functions such as a CPU function and a graphics processing unit (GPU) function. The processor 81 executes an information processing program (e.g., a game program) or other instructions that are stored in storage (e.g., an internal non-transitory storage medium such as a flash memory 84, an external non-transitory storage medium that is attached to the slot 23, or the like), thereby executing the various types of information processing.

The main body apparatus 2 includes a flash memory 84 and a dynamic random access memory (DRAM) 85 as examples of internal storage media built in itself. The flash memory 84 and the DRAM 85 are connected to the CPU 81. The flash memory 84 is mainly used to store various data (or programs) to be saved in the main body apparatus 2. The DRAM 85 is used to temporarily store various data used in information processing. The DRAM 85 and the flash memory 84 are illustrative non-limiting examples of non-transitory computer-readable media.

The main body apparatus 2 includes a slot interface (hereinafter abbreviated to “I/F”) 91. The slot I/F 91 is connected to the processor 81. The slot I/F 91 is connected to the slot 23, and reads and writes data from and to a predetermined type of storage medium (e.g., a dedicated memory card) attached to the slot 23, in accordance with commands from the processor 81.

The processor 81 reads and writes, as appropriate, data from and to the flash memory 84, the DRAM 85, and each of the above storage media, thereby executing the above information processing.

The main body apparatus 2 includes a network communication section 82. The network communication section 82 is connected to the processor 81. The network communication section 82 communicates (specifically, through wireless communication) with an external apparatus via a network. In the present embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a particular protocol or infrared light communication). It should be noted that the wireless communication in the above second communication form achieves the function of allowing so-called “local communication”, in which the main body apparatus 2 can wirelessly communicate with another main body apparatus 2 located in a closed local network area, and the plurality of main body apparatuses 2 directly communicate with each other to exchange data.

The main body apparatus 2 includes a controller communication section 83. The controller communication section 83 is connected to the processor 81. The controller communication section 83 wirelessly communicates with the left controller 3 and/or the right controller 4. The main body apparatus 2 may communicate with the left and right controllers 3 and 4 using any suitable communication method. In the present embodiment, the controller communication section 83 performs communication with the left and right controllers 3 and 4 in accordance with the Bluetooth (registered trademark) standard.

The processor 81 is connected to the left-side terminal 17, the right-side terminal 21, and the lower-side terminal 27. When performing wired communication with the left controller 3, the processor 81 transmits data to the left controller 3 via the left-side terminal 17 and also receives operation data from the left controller 3 via the left-side terminal 17. Further, when performing wired communication with the right controller 4, the processor 81 transmits data to the right controller 4 via the right-side terminal 21 and also receives operation data from the right controller 4 via the right-side terminal 21. Further, when communicating with the cradle, the processor 81 transmits data to the cradle via the lower-side terminal 27. As described above, in the present embodiment, the main body apparatus 2 can perform both wired communication and wireless communication with each of the left and right controllers 3 and 4. Further, when the unified apparatus obtained by attaching the left and right controllers 3 and 4 to the main body apparatus 2 or the main body apparatus 2 alone is attached to the cradle, the main body apparatus 2 can output data (e.g., image data or sound data) to a stationary monitor or the like via the cradle.

Here, the main body apparatus 2 can communicate with a plurality of left controllers 3 simultaneously (or in parallel). Further, the main body apparatus 2 can communicate with a plurality of right controllers 4 simultaneously (or in parallel). Thus, a plurality of users can simultaneously provide inputs to the main body apparatus 2, each using a set of left and right controllers 3 and 4. As a non-limiting example, a first user can provide an input to the main body apparatus 2 using a first set of left and right controllers 3 and 4, and at the same time, a second user can provide an input to the main body apparatus 2 using a second set of left and right controllers 3 and 4.

Further, the display 12 is connected to the processor 81. The processor 81 displays, on the display 12, a generated image (e.g., an image generated by executing the above information processing) and/or an externally obtained image.

The main body apparatus 2 includes a codec circuit 87 and speakers (specifically, a left speaker and a right speaker) 88. The codec circuit 87 is connected to the speakers 88 and an audio input/output terminal 25 and also connected to the processor 81. The codec circuit 87 is for controlling the input and output of audio data to and from the speakers 88 and the sound input/output terminal 25.

The main body apparatus 2 includes a power control section 97 and a battery 98. The power control section 97 is connected to the battery 98 and the processor 81. Further, although not illustrated, the power control section 97 is connected to components of the main body apparatus 2 (specifically, components that receive power supplied from the battery 98, the left-side terminal 17, and the right-side terminal 21). Based on a command from the processor 81, the power control section 97 controls the supply of power from the battery 98 to each of the above components.

Further, the battery 98 is connected to the lower-side terminal 27. When an external charging device (e.g., the cradle) is connected to the lower-side terminal 27, and power is supplied to the main body apparatus 2 via the lower-side terminal 27, the battery 98 is charged with the supplied power.

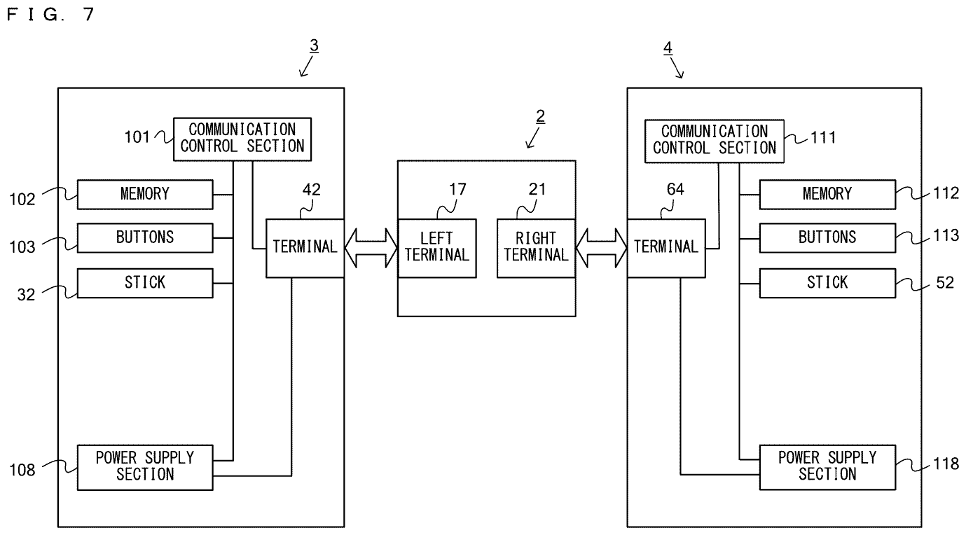

FIG. 7 is a block diagram illustrating non-limiting examples of the internal configurations of the main body apparatus 2, the left controller 3, and the right controller 4. It should be noted that the details of the internal configuration of the main body apparatus 2 are illustrated in FIG. 6 and therefore are omitted in FIG. 7.

The left controller 3 includes a communication control section 101, which communicates with the main body apparatus 2. As illustrated in FIG. 7, the communication control section 101 is connected to components including the terminal 42. In the present embodiment, the communication control section 101 can communicate with the main body apparatus 2 through both wired communication via the terminal 42 and wireless communication without via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the present embodiment, the power supply section 108 includes a battery and a power control circuit. Although not illustrated in FIG. 7, the power control circuit is connected to the battery and also connected to components of the left controller 3 (specifically, components that receive power supplied from the battery).

As illustrated in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, a communication control section 111 can communicate with the main body apparatus 2 through both wired communication via the terminal 64 and wireless communication without via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

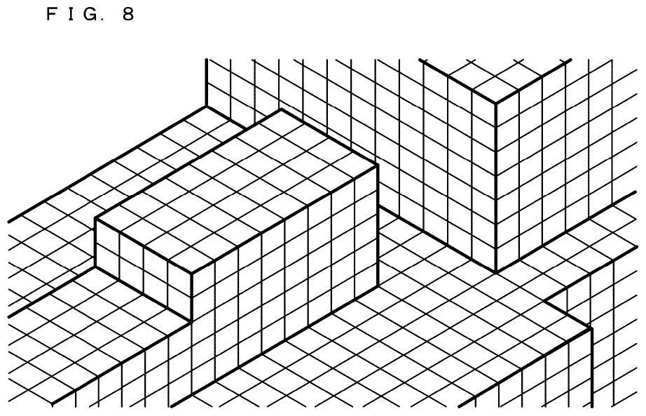

Next, referring to FIG. 8 to FIG. 15, an outline of the process performed on the game system 1 will be described. In the present embodiment, the game system 1 generates a game image in which terrain objects and characters (e.g., a player character that is controlled by the player) are arranged in a game space, which is a three-dimensional virtual space, and displays the game image on a display device. Note that in the present embodiment, the display device on which the game image is displayed may be the display 12 described above, or may be a stationary monitor.

In the present embodiment, for some objects in the game space, the shape is defined by voxel data. Here, voxels are rectangular parallelepiped (more specifically, cubic) regions arranged in a grid pattern in the game space, and voxel data is data that is set for each voxel. Hereinafter, an object whose shape is defined by voxel data will be referred to as a “voxel object”. In the present embodiment, the game system 1 stores voxel data for each of a plurality of voxels that are set in the game space as data for generating voxel objects in the game space.

FIG. 8 is a view showing an example of a terrain object, which is a voxel object. As shown in FIG. 8, in the present embodiment, a terrain object representing a terrain such as a ground surface has its shape defined by voxel data. The cubes shown in FIG. 8 represent a terrain object. Note that in FIG. 8, edges of the terrain object are indicated by thick lines. However, the thick lines are added for the purpose of making the drawings easier to understand, and there is actually no need for edges of the terrain object to be drawn thick.

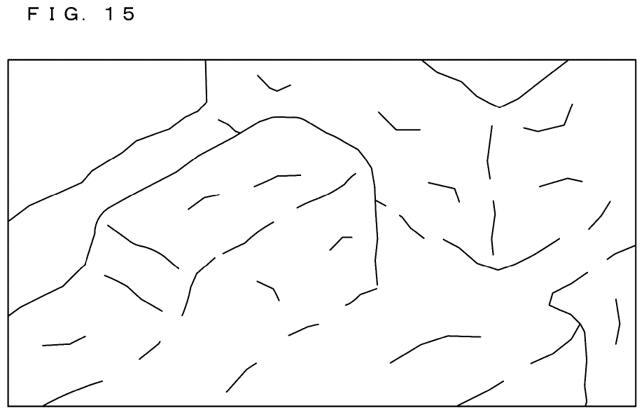

For example, the terrain object shown in FIG. 8 is generated by the following rule: “a cube is placed at the position of a voxel if a parameter included in the voxel data set for the voxel is greater than a predetermined value, and nothing is placed at the position of the voxel if the parameter is less than or equal to the predetermined value”. The terrain object shown in FIG. 8 is shown for the purpose of illustrating the relationship between voxels and voxel objects in an easy-to-understand manner. Note however that in the present embodiment, in practice, a voxel object is generated by such a rule (e.g., based on the voxel data) that results in a terrain object having a complicated shape in comparison with the cubic voxels, such as a terrain object shown in FIG. 15 to be described below, for example. Note that there is no limitation on the rule for determining the shape of the voxel object based on the voxel data. In other embodiments, the game system 1 may generate a voxel object as shown in FIG. 8 based on the object data or may generate a voxel object as shown in FIG. 15 based on the object data.

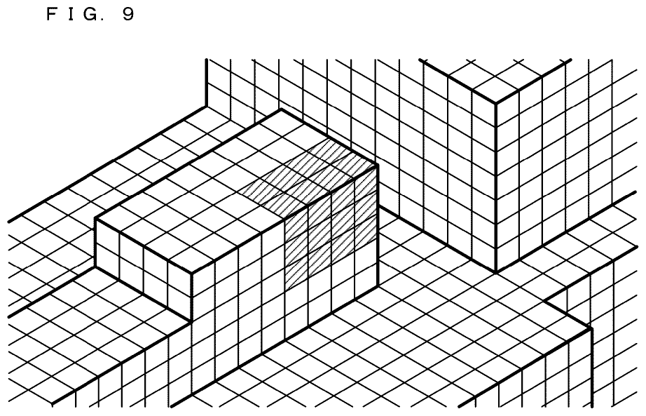

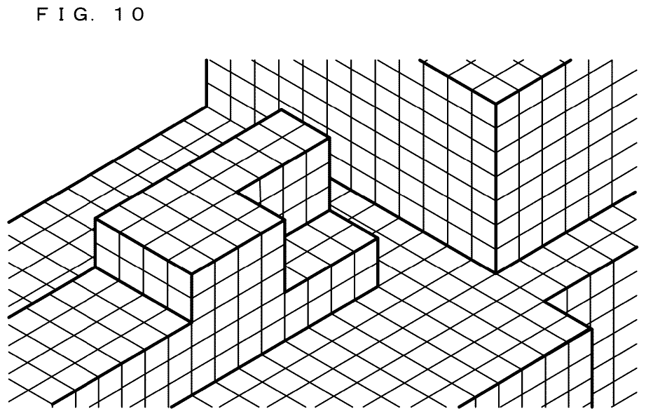

It is possible to change the shape of a voxel object by changing voxel data of voxels. FIG. 9 and FIG. 10 are views showing before and after the removal of a portion of the terrain object shown in FIG. 8. That is, when the hatched portion of the terrain object shown in FIG. 9 is broken, the terrain object changes to a shape as shown in FIG. 10. In such a case, the game system 1 can easily delete the terrain object by rewriting voxel data to be described below so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system 1 can freely change the shape of a voxel object by rewriting the voxel data. For example, when the shape of a terrain object may be changed as a result of the terrain object in a game being broken for some reason (e.g., the player character striking the terrain object), the game system 1 can freely change the shape of the terrain object by changing the voxel data used to generate the terrain object, rather than directly changing data representing the outer shape of the terrain object (e.g., the mesh to be described below).

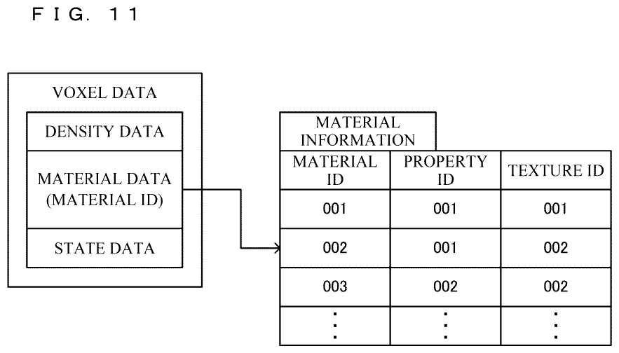

FIG. 11 is a diagram showing an example of content of voxel data. Here, in the present embodiment, the game space can be divided into a plurality of voxels arranged in a grid pattern. The game system 1 stores voxel data for each voxel in the game space so that the voxel data is associated with the voxel. The voxel data represents, for example, the presence/absence of a voxel object in the voxel corresponding to the voxel data.

As shown in FIG. 11, voxel data includes density data. The density data represents a density that indicates the degree to which an object is included in a region defined by each voxel. As will be described in detail below, the position and the shape of the surface of the voxel object (e.g., the mesh to be described below) are determined based on this density. In other words, in the present embodiment, this density is also data that is used to generate a mesh that defines the surface of the voxel object.

In the present embodiment, the density can take an integer value in the range from the lower limit value (e.g., 0) to the upper limit value (e.g., 255). In the present embodiment, in the game system 1, the proportion of the volume to be occupied by the voxel object in a voxel tends to be higher when the density value set for the voxel is higher, and the proportion in a voxel tends to be lower when the density value is lower. For example, if the density is 0, there is no voxel object in the voxel, if the density is 255, the inside of the voxel is entirely the object, and if the density is between 0 and 255, the inside of the voxel is occupied by the object to the proportion that is determined based on the density value. Then, the shape of the voxel mesh, e.g., the shape of the voxel object, is determined based on the density. Note however that the shape of the voxel object generated based on the density does not need to have a volume that exactly matches the proportion represented by the density. For example, the method of generating a voxel object as shown in FIG. 8 and the method of generating a voxel object as shown in FIG. 15 may differ in the volume of the voxel object, even if they are based on the same density.

Note that in other embodiments, the density may indicate either a state in which the voxel object occupies the entirety of the region within the voxel or a state in which no voxel object is included in the region within the voxel. For example, the density data may be data that can take only one of 0 or 1.

As shown in FIG. 11, voxel data includes material data. The material data represents the material (in other words, the substance) of the voxel object generated by the voxel data. Here, in the present embodiment, materials such as sand, rock and soil, for example, are set for voxel objects. That is, in the present embodiment, a plurality of types of materials are provided as materials that can be set for a voxel object, and one of the materials is set for a voxel object.

As shown in FIG. 11, in the present embodiment, the material data represents the identification information of the material (referred to as “material ID”). In the present embodiment, the game system 1 stores material information representing the property and the texture of the material for each material provided in the game. In the present embodiment, the material information represents associations between the material ID, the property of the material and the appearance (specifically, the texture) of the material. Specifically, the material information is information that represents associations between the material ID, identification information of the property of the material (referred to as “property ID”) and identification information of the texture of the material (referred to as “texture ID”) (see FIG. 11).

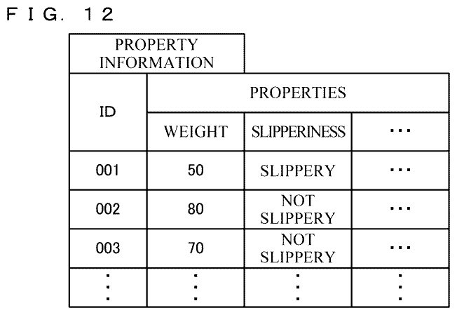

FIG. 12 is a diagram showing an example of property information representing properties of materials. As shown in FIG. 12, the game system 1 stores property information that associates each property ID with information that represents the content of the property represented by the property ID. A property of a material is a property of a voxel object for which the material is set in the game, and it may be information such as weight or slipperiness shown in FIG. 12, for example. Note that there is no limitation on the specific content of the property. For example, the following information may be set as properties of a material.
Temperature
Breakability (e.g., the number of times of impact impartation needed to break a voxel object)
Whether another object can be bonded to a voxel object
Amount of hit points to be regained by the player character when the player character breaks a voxel object
Amount of in-game currency to be gained by the player character when the player character breaks a voxel object

Note that there is no limitation on the specific content of the property to be set for a material. In other embodiments, information different from those listed above may be set as information that represents a property of a material.

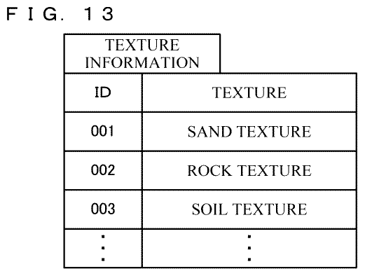

FIG. 13 is a diagram showing an example of texture information representing textures of materials. As shown in FIG. 13, the game system 1 stores texture information that associates the texture ID with the texture represented by the texture ID.

Note that in addition to information of texture, any information regarding the color and/or pattern may be set as data that defines the appearance of a voxel object. For example, a pattern of cracks may be set as information regarding the appearance of a voxel object. By using such a pattern, the game system 1 can generate an image of a voxel object that represents the appearance of cracks.

As described above, in the present embodiment, the material data defines, by the material ID, the property of the voxel object and the texture used for the voxel object. For example, when the material ID represented by the material data included in the voxel data is “002”, the property represented by the property ID “001” that is associated with the material ID in the material information is set as the property of the voxel object corresponding to the voxel data (see arrow shown in FIG. 11). In this case, the texture that is represented by the texture ID “002” associated with the material ID in the material information is applied to the voxel object corresponding to the voxel data (see arrow shown in FIG. 11).

As described above, in the present embodiment, the game system 1 separately manages the property and the texture of the material. Therefore, in the present embodiment, it is possible to easily set a plurality of types of materials having the same property but having different appearances (e.g., different textures) or set a plurality of types of materials having different properties but having the same appearance.

Note that the material data may be any data with which it is possible to identify the property and/or the texture of the material. For example, in other embodiments, the material data may represent the property ID and the texture ID, or may have a data structure that actually includes data representing the property and the texture of the material.

The material data may further represent information related to the material other than the property and the texture described above. For example, the material data may include special effect data that represents the special effect to be triggered upon satisfaction of a special effect triggering condition set for the voxel object (e.g., a portion of the voxel object being broken, or the character stepping on the voxel object). Note that the special effect data may be data that represents a special effect image (e.g., a special effect image showing the voxel object being broken), or may be data that represents a special effect sound (a sound of footstep when the character walks on the voxel object).

As shown in FIG. 11, the voxel data includes state data that represents the state of the voxel object. There is no limitation on the specific content of the state data. For example, the state data may be data that represents whether the voxel object is in a wet state, or may be data that represents the amount of damage applied to the voxel object. The content of the state data may be updated during the game.

In the present embodiment, the surface of the voxel object is represented by a mesh. A mesh is a set of faces (specifically, polygons) placed in the game space. In the present embodiment, the game system 1 generates a mesh for the voxel object based on the voxel data of each voxel set in the game space. An example of how a mesh is generated based on voxel data will now be described.

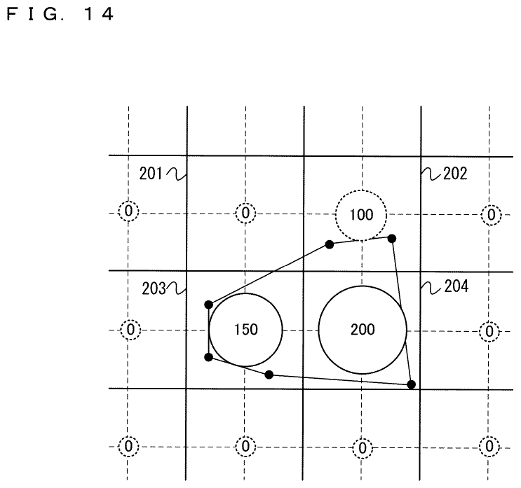

FIG. 14 is a diagram showing an example of a method for generating a mesh.

Note that in FIG. 14, voxels and meshes are represented in two dimensions for the purpose of making the drawing easier to understand and for the sake of discussion, but in practice, a three-dimensional mesh is generated based on voxels in a three-dimensional space.

As described above, in the present embodiment, the density set for the a voxel is in the range of 0 to 255. In the present embodiment, voxels with densities equal to or greater than the reference value are considered to be inside the voxel object, and voxels with densities less than the reference value are considered to be outside the voxel object. It is not necessary to define only voxels with a density of 0 as being outside the voxel object (e.g., reference value=1), and the reference value may be set to 128, for example. In the example shown in FIG. 14, a voxel 201 and the other outer voxels have a density of 0, a voxel 202 has a density of 100, which is less than the reference value, and voxels 203 and 204 have densities of 150 and 200, which are greater than the reference value. In the present embodiment, the game system 1 generates vertices between those voxels whose densities are equal to or greater than the reference value and those voxels whose densities are less than the reference value. Specifically, for each region (region delimited by dotted lines) that straddles eight (four in the figure) adjacent voxels, it is determined whether or not to generate a vertex. That is, a vertex is generated in each region that straddles both a voxel whose density is equal to or greater than the reference value and a voxel whose density is less than the reference value. Then, a polygon mesh is generated by connecting together adjacent vertices if the connection (the boundary between the regions including the vertices) passes through a voxel whose density is equal to or greater than the reference value and a voxel whose density is less than the reference value.

The coordinates of each vertex are determined by comparing densities of adjacent voxels and interpolating based on the difference in density for each of the XYZ axes. In this process, the coordinates can be further calculated based on the normal information. The normal information may be stored in advance for at least some of the voxels, or if not stored, the normal information may also be calculated based on densities between adjacent voxels. Note that in FIG. 14, the density of the voxel 202 is less than the reference value, the voxel 202 is treated as being outside the voxel object in the determination of the presence/absence of a vertex, but the density value itself of the voxel 202 is used to calculate the coordinates of the vertices generated. If the reference value were set to a value lower than the density of the voxel 202, it would result in an increase in the vertices on the upper right side and the upper left side in the voxel 202 of FIG. 14.

By generating a polygon mesh as described above, it is possible to generate a shape whose volume reflects the density of each voxel to some extent. Note however that depending on the relationship with neighboring voxels, it is possible that a voxel with a density of 0 may partially include a region inside the voxel object, or a voxel with a density of 255 may partially include a region outside the voxel object. Since voxels with densities less than the reference value are treated as being outside the voxel object in the present embodiment, there are fewer vertices as compared with a case where those voxels are treated as being inside the voxel object, the volume will be smaller accordingly. That is, there is no need to calculate the polygon mesh so that the volume strictly corresponds to the density value.

FIG. 15 shows an example of a game image including a terrain object. In the present embodiment, by generating a mesh as described above, the voxel object can be made in a shape with complicated irregularities compared to the cubic voxels, for example.

Note that there is no limitation on the method of generating a mesh based on voxel data. For example, in other embodiments, if the density of the voxel data is greater than a predetermined value, a mesh may be generated so that a cube is placed in the voxel (see FIG. 8).

For each face of the mesh generated as described above, the game system 1 determines the appearance (e.g., color and/or pattern) of each such face according to the material identified by the voxel data. Specifically, the game system 1 determines the texture to be used for rendering each face of the mesh based on the voxel data, and maps the determined texture to each face to generate an image of the voxel object. Note that the texture to be mapped to each face of the mesh is determined based on the voxel data of the voxel used to generate the face (which will be referred to as the target voxel) among the voxels where the voxel object exists. Note that the target voxel is, for example, one or more voxels located around the face, although it depends on the mesh generation method. That is, the texture mapped to a face of the mesh is determined to be a texture corresponding to the material set for one or more voxels placed around the face.

Note that in other embodiments, one voxel data may include multiple types (e.g., two types) of material data. In such a case, the voxel data includes ratio data related to the multiple types of material data. The ratio data is data for determining the texture to be used for the voxel object, and represents the ratio by which each of the materials (specifically, the texture corresponding to the material) represented by the multiple types of material data influences the appearance (specifically, the color and/or pattern) of the voxel object. When determining the texture to be mapped to each face of the mesh, the texture is determined based on various data (specifically, density data, multiple types of material data and ratio data) included in the voxel data of the target voxel. For example, when multiple types of materials are set for a target voxel corresponding to one face, a texture corresponding to the (one type of) material with the greatest degree of influence may be used while taking the ratio into consideration, or textures corresponding to multiple types of materials may be used while taking the ratio into consideration.

In other embodiments, there may be both voxel objects for which voxel data including one type of material data is used, and voxel objects for which voxel data including two types of material data is used.

As described above, in the present embodiment, the game system 1 sets the color and/or pattern of the mesh of the voxel object based on appearance data (specifically, a texture ID representing a texture) that defines the color and/or pattern of the voxel object for each voxel. Specifically, for a mesh to be generated based on voxel data of a certain voxel, among meshes of voxel objects, the game system 1 applies the texture represented by the appearance data for the voxel to the mesh of the voxel object that is generated based on the voxel data for the certain voxel. Thus, it is possible to set the color and/or pattern of the voxel object using the appearance data set for the voxel.

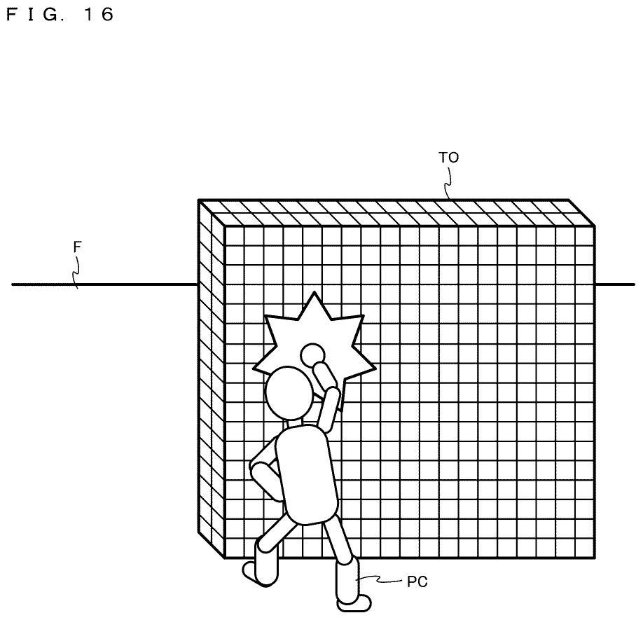

Next, an example of game play in which a player character is operated in a game space according to the user's operation performed on the game system 1 will be described with reference to FIGS. 16 to 19. For example, in the present example, a player character PC appearing in the game space displayed on the display 12 is operated according to the user's operation performed on the operation buttons and sticks of the left controller 3 and/or the right controller 4 of the game system 1 in the unified form, the user's touch operation performed on the touch panel 13 of the main body apparatus 2, the user's operation of moving the entire game system 1 or changing the orientation of the game system 1, and the like.

FIG. 16 is a diagram showing an example of a game image in which the player character PC performs an action of breaking a terrain object TO displayed on the display 12. In FIG. 16, the player character PC is performing a breaking action such as punching a terrain object TO provided on a game field F according to the user's operation. Here, the terrain object TO is an example of a voxel object that is generated based on the above voxel data, and a surface of which is represented by a mesh. In the example of FIG. 16, a voxel space in which voxels are specified is set on the game field F in the game space, and the terrain object TO is generated on the game field F by a plurality of voxels specified in the voxel space. Here, at least one voxel space is set in at least a portion of the game space in order to specify a plurality of voxels. For each voxel space, the length (resolution) of an edge of a voxel, the vectors (orientations) of the x-, y-, and z-axes of a global coordinate system in a vector space, the length of the voxel space in each of the x-, y-, and z-directions, and a location of the voxel space in the game space, and the like are specified. Although an object is rendered by a block mesh in FIGS. 16 to 18, as an example, for the sake of convenience, an object may be actually rendered by generation of a mesh having an appearance as shown in FIG. 15 using the technique described with reference to FIG. 14.

In the present example, at least a portion of the terrain object TO can be broken to disappear by the player character PC performing an action of breaking the terrain object TO. As an example, as shown in FIG. 16, the terrain object TO can be broken such that the terrain object TO is partially deformed, so that a portion thereof disappears, by the player character PC performing an action of hitting a portion of the terrain object TO.

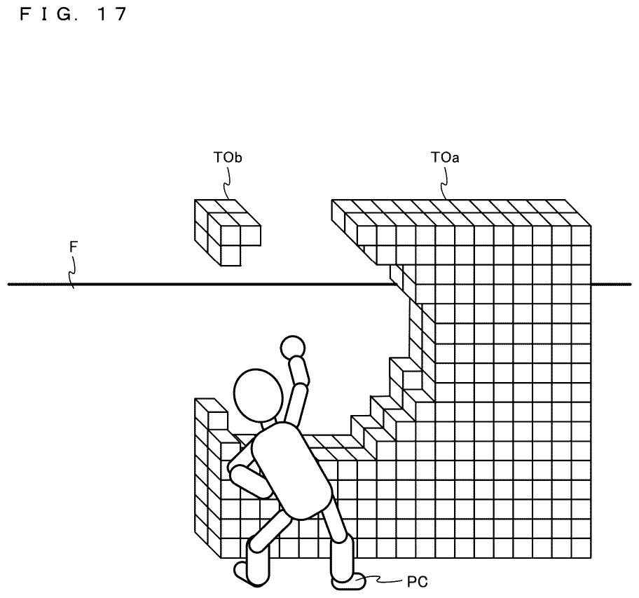

FIG. 17 is a diagram showing an example of a game image in which the player character PC has broken the terrain object TO. As shown in FIG. 17, the terrain object TO has been partially broken and deformed by the player character PC's breaking action, so that a portion thereof has been removed from the game space. Specifically, a cylindrical empty portion is formed in a portion of the terrain object TO, which is in the shape of a flat board, by the player character PC's breaking action, so that the terrain object TO is deformed and separated into a terrain object TOa and a terrain object TOb by the empty portion.

The terrain object TOa has a greater size than that of the terrain object TOb, and is left in the game space and remains placed on the game field F. In contrast to this, the terrain object TOb is a broken piece (debris) having a relatively small size, and is left in the game space and is located away from the game field F. In other words, the terrain object TOb is left, staying in the air in the game space, which has poor appearance and seems unnatural to the user. In addition, it may take time and effort for the user to deal with such a broken piece. In the present example, broken pieces produced by breaking the terrain object TO are automatically removed.

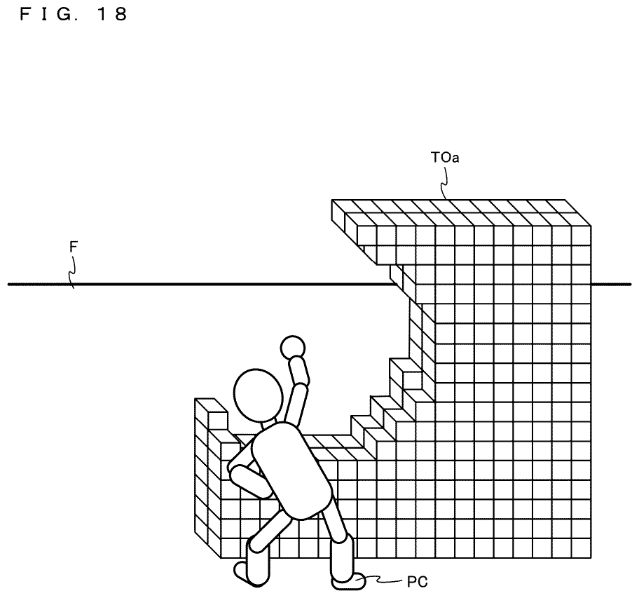

FIG. 18 is a diagram showing an example of a game image in which broken pieces produced by the player character PC breaking the terrain object TO have been removed. As shown in FIG. 18, the terrain object TOb displayed in the game image of FIG. 17 has been removed from the game space, and only the terrain object TOa which is a portion of the terrain object TO is left on the game field F after the breaking action of the player character PC. Although the state in which the terrain object TOb is left is explained and such a game image example is shown in FIG. 17 in order to explain broken pieces of the terrain object TO left after the breaking action, the user may not recognize the state in which the terrain object TOb is left, in an actual game process. As an example, the process of breaking the terrain object TO and the process of removing the terrain object TOb, which is a broken piece thereof, may be executed substantially simultaneously with the player character PC's breaking action (e.g., with the same processing timing). As another example, a scene may be displayed in which the terrain object TO is broken due to the player character PC's breaking action, so that an effect image that the terrain object TOb, which is a broken piece thereof, is flying away in the air in the game space, or the like, may be displayed, and thereafter, the broken piece may be removed.

In the present example, after the player character PC breaks the terrain object TO, one or more of the broken pieces of the terrain object TO left in the game space that have a size smaller than a predetermined reference are subjected to the removal process. At least one of the broken pieces of the terrain object TO that further satisfies at least one of the following conditions may be subjected to the removal process. A first condition is that a broken piece at least a portion of which is included in a predetermined range including the broken range of the terrain object TO is subjected to the removal process. A second condition is that a broken piece which is not in contact with another object or the game field is subjected to the removal process. Typically, a broken piece staying alone in the air is subjected to the removal process. Note that if a condition is provided that a broken piece is not in contact with another object made of the same material, broken pieces made of a single material left in another object made of a different material can be subjected to the removal process in addition to broken pieces left in the air.

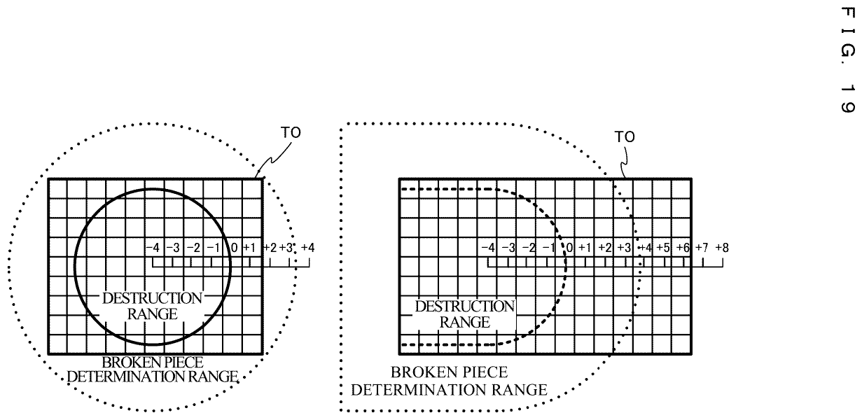

In the present example, by changing the voxel data of the voxels constituting the terrain object TO, the process of how the terrain object TO is broken and deformed/removed can be represented. FIG. 19 is a diagram showing an example of a destruction range of voxels to be broken in a terrain object TO, and a broken piece determination range of voxels for determining broken pieces of the terrain object TO. Note that the left figure of FIG. 19 shows the front surface (surface to be broken) of the terrain object TO as viewed from the player character PC, which breaks the terrain object TO. The right figure of FIG. 19 shows the right side surface of the terrain object TO shown in the left figure.

The destruction range of the terrain object TO to be broken by the player character PC's breaking action is set based on the location where the player character PC breaks the terrain object TO, the player character PC's strength and capability, and the strength (material) of the terrain object TO. For example, the destruction range is set such that a distance from a reference location set based on a location where the player character PC has performed a breaking action in the game space is within a predetermined distance. In the example of FIG. 19, for the terrain object TO, a bell-shaped destruction range having a semi-spherical shape at a deepest portion lost due to the destruction is formed around the location where the player character PC has performed a breaking action. Note that the shape of the destruction range may be other shapes such as a sphere, ellipsoid, cube, cylinder, wedge, shapes generated by 3D software, and in addition, these shapes a portion of which has been removed, and the like. The destruction range may be located around a location where the player character PC has performed a breaking action (e.g., a location where the player character PC's punching first has reached) in the game space, or around a location at a predetermined distance in front of said location as viewed from the player character PC. Note that the destruction range corresponds to an example of a first range that, when an event occurs for a terrain based on the player's operation input, is set based on a location of the occurrence of the event, for terrain volume data.

A voxel to be removed/deformed with reference to the above destruction range is determined using a signed distance field (SDF). The SDF of a voxel indicates a distance between the voxel and a surface of the destruction range closest to that voxel. It is assumed that the SDF of a voxel located on a surface of the destruction range is zero, the SDF of a voxel located outside the destruction range is positive, and the SDF of a voxel located inside the destruction range is negative. A removal/deformation process is set for each voxel, depending on the SDF of the voxel. For example, for a voxel to be removed, a portion of the terrain object TO that corresponds to the voxel is removed by rewriting the voxel data of the voxel such that the voxel data indicates the absence of a terrain object.

For example, in the present example, removal/deformation of a voxel is controlled by changing a density included in the voxel data thereof. For example, the density is an index indicating the proportion of the volume of a voxel object to a region defined by a voxel. The density can take an integer value in the range from the lower limit value (e.g., 0) to the upper limit value (e.g., 255). It is assumed that the higher the value of the density set for a voxel, the greater the proportion in the voxel, and the lower the value of the density, the smaller the proportion in the voxel. It is also assumed that no voxel object is included in a voxel the value of the density of which is the lower limit (e.g., 0), and a voxel object is included throughout a voxel the value of the density of which is the upper limit value (e.g., 255). In other words, if the value of the density is greater than the lower limit value, the voxel data indicates the presence of a terrain object, and if the value of the density is the lower limit value, the voxel data indicates the absence of a terrain object. Note that the shape of a voxel mesh generated based on the density does not need to have a volume exactly corresponding to the value of the density.

In the present example, removal/deformation of a voxel is controlled by rewriting the density of the voxel based on the SDF of the voxel. Specifically, by rewriting and reducing the densities of at least voxels having a negative SDF distance, at least a portion of the voxels included in the destruction range are changed to the state in which no terrain object is present. As a first example, by rewriting the densities of voxels having a negative SDF distance to the lower limit value, the voxels, which are included in the destruction range, are set to the state in which no terrain object is present, and by maintaining the values of the densities of voxels having a positive SDF distance unchanged, the voxels, which are out of the destruction range, are set to the state in which a terrain object is present. As a second example, by rewriting the densities of voxels having a negative SDF distance such that the value of the density of the voxel decreases with an increase in the absolute value of the distance, and rewriting the densities of voxels whose absolute value is greater than a predetermined value to the lower limit value, a portion of the voxels, which are included in the destruction range, are set to the state in which no terrain object is present, and by maintaining the values of the densities of voxels having a positive SDF distance unchanged, the voxels, which are out of the destruction range, are set to the state in which a terrain object is present. As a third example, by rewriting the densities of voxels having a negative SDF distance to the lower limit value, the voxels, which are included in the destruction range, are set to the state in which no terrain object is present, and by rewriting the densities of voxels having a positive SDF distance such that the value of the density of the voxel decreases with a decrease in the absolute value of the distance, a portion of the voxels, which are out of the destruction range, are set to the state in which the voxel is not entirely occupied by a voxel object.

Note that the density in the voxel data may be rewritten by adjusting the change amount of the density, depending on the type and state of a material indicated by material data included in the voxel data. For example, the change amount of the density may be adjusted (e.g., the change amount of the density to be rewritten is increased for a more breakable material), depending on a property (e.g., breakability or temperature) of a material indicated by the material data.

Alternatively, when the density in the voxel data is rewritten, the change amount of the density may be adjusted, depending on state data included in the voxel data. For example, the state data indicates the amount of damage applied to the terrain object TO by the player character PC. As an example, whether to reduce the density in the voxel data and whether to increase the amount of damage may be determined based on a relationship between the offensive strength of the player character PC and the defensive strength of the terrain object TO. Specifically, based on a relationship between the hardness of the offensive entity (e.g., the hardness of a first of the player character PC punching the terrain object TO) and the hardness of the defensive (attacked) entity (the hardness of the material of the terrain object TO), the density in the destruction range is rewritten if the hardness of the offensive entity is greater, and neither the density in the destruction range nor the amount of damage is rewritten if the hardness of the defensive (attacked) entity is greater. If the hardness of the offensive entity is substantially equal to the hardness of the defensive (attacked) entity, the amount of damage to voxels in the destruction range is increased, and if the amount of the damage exceeds the acceptable amount of the voxel (the damage endurance value of the material), the densities of the voxels are rewritten. Note that the amount of damage to a voxel exceeds the acceptable amount of the voxel, the density of the voxel may be set to zero, e.g., the voxel may be removed. Thus, the amount of damage to a voxel can serve as voxel data indicating the absence of a terrain.

After the density is rewritten as described above, a mesh is newly formed on a surface (specifically, a surface that is newly exposed to the outside by breaking) of the terrain object TO to update the display. For example, when an event occurs in which the terrain object TO is broken, a mesh is newly formed by recalculating mesh vertices in a range including voxels whose voxel data has been rewritten due to the destruction. As an example, as shown in FIG. 14, mesh vertices are generated. Thus, after voxels are removed, a new mesh is generated based on an algorithm that recalculates mesh vertices based on the densities of voxels, so that broken pieces of the terrain object TO occur. In the present example, even when broken pieces are left due to generation of such a new mesh, the broken pieces are removed. Thereafter, texture for use in rendering each face of the mesh is determined based on the voxel data, and the determined texture is mapped to each face, whereby an image of the broken terrain object TO is generated. Note that the range in which mesh recalculation is performed may be a chunk including voxels whose voxel data has been rewritten (a process unit including a predetermined number of voxels). For example, if a chunk includes 16×16×16 voxels, and recalculation is performed on chunks including voxels whose voxel data has been rewritten, processing can be reduced compared to when a mesh is recalculated throughout the game space. The range may be a voxel space in which voxels whose voxel data has been rewritten are located, or the entire terrain object TO, which includes voxels whose voxel data has been rewritten. If the processing load is not so great, a mesh may be recalculated throughout the game space.

The broken piece determination range based on which it is determined whether or not broken pieces of the terrain object TO produced by the player character PC's breaking action are to be subjected to the removal process, is set based on a location where the breaking action has been performed. For example, the broken piece determination range is set to include at least the destruction range set for the terrain object TO. In the example of FIG. 19, for the terrain object TO, the broken piece determination range is set so as to extend, by a predetermined distance, outward from the destruction range in which the player character PC has performed a breaking action, and thereby encompass that destruction range. Note that the broken piece determination range may be set based on other references. For example, as a first example, the broken piece determination range may be one that has a positive predetermined SDF distance. As a second example, the broken piece determination range may be an entire terrain object TO in which a destruction range has occurred due to the player character PC's breaking action, or an entire voxel space in which a terrain object TO is specified. As a third example, the broken piece determination range may be the above chunk that includes voxels whose voxel data has been rewritten due to the player character PC's breaking action. Note that the broken piece determination range corresponds to an example of a second range including at least a first range.

Thereafter, if, in the broken piece determination range, a small separate region is present in which voxels whose voxel data indicates the presence of a terrain object are adjacent and contiguous to each other, and whose size is smaller than a predetermined reference, the voxel data of the voxels included in the small region is rewritten so as to indicate the absence of a terrain. As a first example, if, in the broken piece determination range, the sum of the values of the densities of the voxels included in a region in which voxels whose voxel data indicates the presence of a terrain object are adjacent and contiguous to each other is smaller than a predetermined threshold, the region is determined to be the above small region. In that case, even a region whose size is smaller than the size of a single voxel can be determined to be the small region. As a second example, if, in the broken piece determination range, the number of voxels in a region in which voxels whose voxel data indicates the presence of a terrain object are adjacent and contiguous to each other is smaller than a predetermined threshold, the region is determined to be the small region. By such a process, broken pieces produced by breaking the terrain object TO and identified as the small region are removed. Note that the small region in the broken piece determination range may be detected by any suitable technique. For example, the small region may be detected using a clustering process using a three-dimensional filling process.

Note that all or a portion of a broken piece of the terrain object TO to be subjected to the removal process may be included in the broken piece determination range. Typically, a broken piece of the terrain object TO to be subjected to the removal process may stay alone in the air in the game space, and is not connected to the terrain object or other objects not only in the broken piece determination range but also out of the broken pieces determination range. However, a broken piece that is in contact with a game field (ground) or another object, a broken piece possessed by a character, and the like may be subjected to the removal process. It is assumed that a broken piece of the terrain object TO to be subjected to the removal process is at rest in the air in the game space. As another example, a broken piece that is moving in the air in the game space, or the like, may be subjected to the removal process.

In the foregoing, as an example of an event in which the terrain object TO is removed, a portion of the terrain object TO is broken and deformed or removed due to the player character PC's breaking action hitting the terrain object TO, e.g., the player character PC punching the terrain object TO. The terrain object TO may also be removed due to other events. For example, in an event, the terrain object TO may be broken by being hit by the entire body or another part such as a leg of the player character PC, or by being hit by the player character PC with an item such as a weapon. In an event, the terrain object TO may also be broken by being hit by another object thrown or kicked by the player character PC, or by being hit by a bullet object fired or launched by the player character PC, or the like. The terrain object TO may also be removed (deformed) due to such events.

In the foregoing, the terrain object TO is used as an example of an object that is partially removed from the game space. Other voxel objects may, of course, be removed from the game space by a similar process. For example, other voxel objects such as buildings and trees provided in the game space, moving bodies such as vehicles moving in the game space, other characters such as opponent characters present in the game space, items provided in the game space, objects such as foods and tools provided in the game space, may be subjected to a similar removal process.

In the foregoing, as an example, the broken piece determination range is set so as to include at least the destruction range set for the terrain object TO. Alternatively, a portion of the destruction range may be out of the broken piece determination range, or the broken piece determination range may be set in the destruction range. As an example of the former case, the broken piece determination range may be set on a side of the destruction range set for the terrain object TO on which the player character PC is located. In that case, a region of the destruction range farthest from the player character PC may be out of the broken piece determination range.

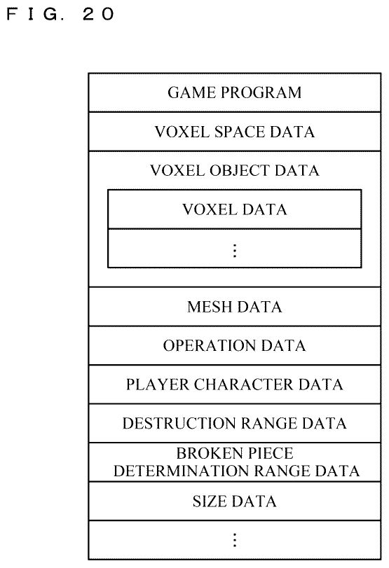

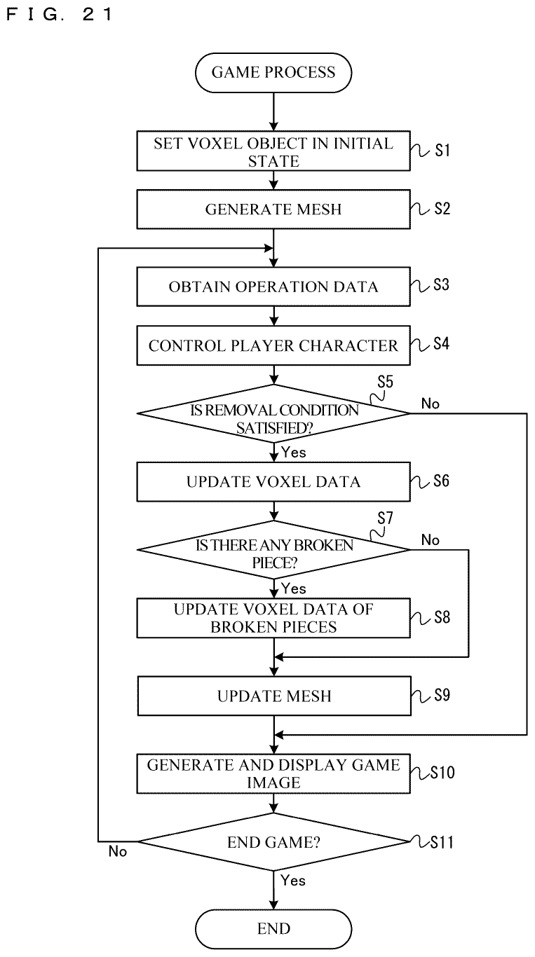

Next, a specific example of an information process of the game system 1 will be described with reference to FIG. 20 and FIG. 21.

FIG. 20 is a diagram showing an example of various kinds of data used in an information process executed in the game system 1. As shown in FIG. 20, the game system 1 stores a game program, voxel space data, voxel object data, mesh data, operation data, player character data, destruction range data, broken piece determination range data, size data, and the like. The game program and the voxel space data are previously stored in the game system 1 before a game process is executed. The game program and the voxel space data are, for example, stored in a storage medium attached to the slot 23 of the main body apparatus 2. The voxel object data, mesh data, operation data, player character data, destruction range data, broken piece determination range data, and size data are generated during execution of a game process. The voxel object data, mesh data, operation data, player character data, destruction range data, broken piece determination range data, and size data are, for example, stored into the DRAM 85 of the main body apparatus 2.

The game program is for executing a game process (specifically, the game process shown in FIG. 21) of the present example.

The voxel space data specifies voxels that are set in the game space. Specifically, the voxel space data indicates the length of an edge of each voxel, and the orientation of each edge of the voxel in the game space. In the case in which voxels are set only in part of the game space, the voxel space data includes data indicating the location and size of a space in which voxels are set (e.g., a voxel space) (e.g., data indicating a range of the game space in which voxels are set).

The voxel object data indicates a voxel object that is provided in the game space. Specifically, the voxel object data includes voxel data for each unit region in all or part of the game space.

The mesh data indicates a mesh that is set for a voxel object which is provided in the game space. The mesh data includes, for example, data indicating the vertices of a mesh.

The operation data is obtained, as appropriate, from each of the left controller 3 and/or the right controller 4 and the main body apparatus 2. As described above, the operation data obtained from each of the left controller 3 and/or the right controller 4 and the main body apparatus 2 includes information about an input from each input section (specifically, each button, an analog stick, or a touch panel) (specifically, information about an operation). In the present example, operation data is obtained from each of the left controller 3 and/or the right controller 4 and the main body apparatus 2. The obtained operation data is used to update the operation data as appropriate. Note that the operation data may be updated for each frame that is the cycle of a process (to be described below) executed in the game system 1, or may be updated each time operation data is obtained.

The player character data indicates the place and position of the player character PC placed in the virtual space, the movement and state in the virtual space of the player character PC, and the like.

The destruction range data indicates a destruction range that is set when a terrain object TO is broken by the player character PC. The broken piece determination range data indicates a broken piece determination range that is set when a terrain object TO is broken by the player character PC. The size data indicates the sizes of broken pieces of a terrain object TO included in the broken piece determination range.

Note that in addition to the data shown in FIG. 20, the game system 1 stores, for example, data of the above property information and texture information as data that is previously stored in the game system 1 before a game process is executed.

FIG. 21 is a flowchart showing an example of a flow of a game process that is executed in the game system 1. In the present example, a series of steps shown in FIG. 21 are executed by the processor 81 executing the game program. The game process of FIG. 21 is started with any suitable timing. As an example, the game process of FIG. 21 is started according to an instruction to start a game that is provided by a player during execution of the game program.

Note that in the present embodiment, it is assumed that the processor 81 of the main body apparatus 2 executes the game program stored in the game system 1 to execute each step of FIG. 21. Note that in another exemplary embodiment, a portion of the steps may be executed by a processor (e.g., a dedicated circuit) other than the processor 81. In the case in which the game system 1 can communicate with another information processing device (e.g., a server), a portion of the steps of FIG. 21 may be executed by the information processing device. In other words, the steps of FIG. 21 may be executed by a plurality of information processing devices including the main body apparatus 2 working together. The steps of FIG. 21, which are merely for illustrative purposes, may be executed in a different order, or another step may be executed in addition to (or instead of) each step, if a similar effect is obtained.

The processor 81 executes the steps of FIG. 21 using a memory (e.g., the DRAM 85). Specifically, the processor 81 stores information (in other words, data) obtained in each process step into a memory, and reads and uses the information from the memory when the information is required in a subsequent process step.

In FIG. 21, the processor 81 sets a voxel object in an initial state in the game space (step S1), and proceeds to the next step. Specifically, the processor 81 obtains voxel data indicating the arrangement of a voxel object in an initial state, and stores (in other words, writes) all or a portion of the obtained voxel data as the voxel object data into the DRAM 85. Note that the voxel data indicating the arrangement of a voxel object in an initial state is, for example, stored in a storage medium attached to the slot 23 of the main body apparatus 2. Note that a processor that stores, into a storage medium, terrain volume data that indicates a terrain in a virtual space, and holds voxel data indicating the presence of a terrain for each voxel included in a voxel space set in the virtual space, corresponds to the processor 81 executing step S1, for example.

Note that voxel data that is written as the voxel object data into the DRAM 85 may be voxel data corresponding to a partial range that is used in generation of a game image, of the voxel data corresponding to the entire range of the game space. For example, the processor 81 may generate an image of an object using voxel data corresponding to only a partial range of the game space (e.g., a range within a predetermined distance from the location of a virtual camera). In that case, the voxel object data may include voxel data within that range. When voxel data corresponding to a partial range of the game space is written, a process similar to step S1 is executed with appropriate timing (e.g., at a timing when the location of the virtual camera is moved by at least a predetermined distance) during execution of steps S3 to S11 to be described below.

Next, the processor 81 generates a mesh for the voxel object (step S2), and proceeds to the next step, in which the processor 81 starts a game, and repeatedly executes steps S3 to S11 in the game. A mesh is generated by the above method. Here, the processor 81 generates a mesh based on the voxel object data stored in the DRAM 85. As a result of step S2, a voxel object such as a terrain object is constructed in the game space.

Next, the processor 81 obtains data corresponding to the user's operation from the left controller 3, the right controller 4, and/or the main body apparatus 2, updates the operation data (step S3), and proceeds to the next step.

Next, the processor 81 controls actions of various objects appearing in the game space (e.g., a player character and an opponent character) (step S4), and proceeds to the next step. For example, the processor 81 controls the player character's action based on the operation data obtained in step S3, and updates the player character data. The processor 81 also controls an opponent character's action based on an algorithm specified in the game program.

Next, the processor 81 determines whether or not a removal condition for removal of at least a portion of the voxel object is satisfied (step S5). For example, if the player character PC has hit the terrain object TO, the processor 81 sets a location where the terrain object TO has been hit and a surrounding range as a destruction range, updates the destruction range data, breaks the terrain object TO (voxel object) present within the destruction range, and removes the broken portion. As an example, in order to represent a state that the destruction range has been broken, the densities indicated by the voxel data of at least a portion of the voxels included in the destruction range are set to zero, whereby the object in the destruction range is removed. Therefore, if a voxel(s) of the voxel object is included in the destruction range hit by the player character, the result of the determination by the processor 81 is step S5 is positive. If the removal condition is satisfied, the processor 81 proceeds to step S6. Otherwise, i.e., if the removal condition is not satisfied, the processor 81 proceeds to step S10.

In step S6, the processor 81 updates the voxel data related to the voxel object that satisfies the removal condition, and proceeds to the next step. For example, in order to remove at least a portion of the voxel object that satisfies the removal condition, the processor 81 changes the densities of voxels in a portion hit by the player character and a surrounding portion, and updates the voxel data corresponding to each voxel. The processor 81 reduces the densities of voxels around the destruction range to be removed (e.g., the hit range) (provided that the reduced density is at least zero), and thereby deforms the voxel object in the voxels around the destruction range. Specifically, the processor 81 updates the voxel object data stored in the DRAM 85 such that the density data is changed for the voxel data of the voxels in the range to be removed and a surrounding portion. Note that the processor 81 may update the density data such that the density indicates a value less than the reference value. For example, the processor 81 may set the densities of voxels in a portion (destruction range) hit by the player character to zero, and may reduce the densities of voxels in a surrounding region by a predetermined value. Note that a processor that when an event occurs with respect to a terrain based on a player's operation input, updates voxel data such that the voxel data of at least a portion of voxels included in a first range set based on a location of the occurrence of the event indicates the absence of the terrain, with respect to terrain volume data, corresponds to the processor 81 executing step S6, for example.

Next, the processor 81 determines whether or not a broken piece(s) to be removed is present in the game space (step S7). For example, the processor 81 sets a broken piece determination range including at least the destruction range set in step S5, and updates the broken piece determination range data. Thereafter, the processor 81 calculates a size of a region(s) in which voxels having voxel data indicating the presence of a voxel object (e.g., voxel data having a non-zero density) are adjacent and contiguous to each other, in the broken piece determination range, and updates the size data. If a small separate region whose size is smaller than a predetermined reference is present, the result of the determination in step S7 is positive. Here, the small separate region refers to a region that is not connected to any other object, not only in the broken piece determination range, but also out of the broken pieces determination range. Note that as described above, the broken piece determination range may be set so as to extend, by a predetermined distance, outward from the destruction range, or may be a range having a predetermined positive SDF distance, an entire voxel object or voxel space in which the destruction range is set, or a predetermined chunk including the destruction range. If a broken piece(s) to be removed is present, the processor 81 proceeds to step S8. Otherwise, i.e., if no broken pieces to be removed are present, the processor 81 proceeds to step S9.

In step S8, the processor 81 updates the voxel data related to the broken pieces to be removed that have been determined in step S7, and proceeds to step S9. For example, the processor 81 changes the densities of the voxels of the broken pieces to be removed that have been determined, so as to remove the broken pieces, and updates the voxel data of each voxel. Specifically, the processor 81 updates the voxel object data stored in the DRAM 85 (e.g., the density is updated with zero) so as to change the density data in the voxel data of the voxels in the broken pieces to be removed. Note that a processor that if, in a second range including at least a first range, a small separate region in which voxels having voxel data indicating the presence of a terrain are adjacent and contiguous to each other, and which has a size smaller than a predetermined reference, updates the voxel data of the voxels included in the small region such that the voxel data indicates the absence of the terrain, corresponds to the processor 81 executing step S8, for example.

In step S9, the processor 81 updates the mesh for the voxel object whose voxel data has been changed in steps S6 and S8, and proceeds to step S10. Specifically, the processor 81 generates a mesh for the voxel object that satisfies the removal condition and from which the broken pieces to be removed have been removed, based on the voxel object data updated in steps S6 and S8. Thus, a mesh for a terrain object can be dynamically changed in a game, and broken pieces left in the air can be removed. The processor 81 updates the mesh data stored in in the DRAM 85 such that the mesh data indicates the newly generated mesh. Note that the mesh updating process of step S9 may be executed after step S6.

In step S10, the processor 81 generates and displays a game image of the game space on a display device, and proceeds to the next step. Specifically, the processor 81 generates a game image of the game space including the voxel object and other objects (e.g., a player character and an opponent character). Note that an image of a voxel object is generated by the above method using the voxel object data and the mesh data stored in the DRAM 85. An image of a player character is generated using the player character data stored in the DRAM 85. Thereafter, the processor 81 displays the generated game image on a display device. Note that in a game, step S10 is repeatedly executed at a rate of once per predetermined time (e.g., one frame time). Note that a processor that generates an image of a virtual space by rendering at least a polygon mesh representing a surface of a terrain, based on terrain volume data, corresponds to the processor 81 executing steps S9 and/or S10, for example.

Next, the processor 81 determines whether or not to end the game (step S11). In step S11, the game process is ended, for example, if a condition for ending the game process is satisfied, the user has performed an operation of ending the game process, or the like. If the processor 81 does not determine to end the game process, the processor 81 returns to step S3, and repeats the process. Otherwise, i.e., if the processor 81 determines to end the game process, the processor 81 ends the flowchart. Following this, steps S3 to S11 are repeated executed until the processor 81 determines to end the game process in step S11.

Thus, in the present example, small broken pieces are prevented from being left after deformation of a terrain object or the like generated from voxels due to the player character PC's breaking action or the like, whereby deformation having a high degree of freedom can be attained with high operability.

As can be seen from the above flowchart, when an event in which the player character PC breaks the terrain object TO occurs, the process of removing broken voxels in step S6 and the process of removing broken pieces left after destruction in step S8 are executed. The execution of these two voxel data updating processes can quickly remove broken pieces. In addition, the two voxel data updating processes are executed while the player character PC is performing an action of breaking the terrain object TO. Therefore, even if more voxels than those expected to be removed by the destruction are removed, a game image shows better destruction, thereby preventing the user from feeling unnatural.

The game system 1 may be any suitable apparatus, including a handheld game apparatus, or any suitable handheld electronic apparatus (a personal digital assistant (PDA), mobile telephone, personal computer, camera, tablet computer, etc.), etc. In that case, an input apparatus for performing an operation of causing a player object PC to perform an action may be, instead of the left controller 3 or the right controller 4, another controller, mouse, touchpad, touch panel, trackball, keyboard, directional pad, slidepad, etc.

In the foregoing, the information processes are performed in the game system 1. Alternatively, at least a portion of the process steps may be performed in another apparatus. For example, when the game system 1 can also communicate with another apparatus (e.g., another server, another information processing apparatus, another image display apparatus, another game apparatus, another mobile terminal, etc.), the process steps may be executed in cooperation with the second apparatus. By thus causing another apparatus to perform a portion of the process steps, a process similar to the above process can be performed. The above information process may be executed by a single processor or a plurality of cooperating processors included in an information processing system including at least one information processing apparatus. In the above non-limiting example, the information processes can be performed by the processor 81 of the game system 1 executing predetermined programs. Alternatively, all or a portion of the above processes may be performed by a dedicated circuit included in the game system 1.

Here, according to the above non-limiting variation, the present example can be implanted in a so-called cloud computing system form or distributed wide-area and local-area network system forms. For example, in a distributed local-area network system, the above process can be executed by cooperation between a stationary information processing apparatus (a stationary game apparatus) and a mobile information processing apparatus (handheld game apparatus). It should be noted that, in these system forms, each of the above steps may be performed by substantially any of the apparatuses, and the present example may be implemented by assigning the steps to the apparatuses in substantially any manner.

The order of steps, setting values, conditions for determination, etc., used in the above information process are merely illustrative, and of course, other order of steps, setting values, conditions for determination, etc., may be used to implement the present example.

The above programs may be supplied to the game system 1 not only through an external storage medium, such as an external memory, but also through a wired or wireless communication line. The program may be previously stored in a non-volatile storage device in the game system 1. Examples of an information storage medium storing the program include non-volatile memories, and in addition, CD-ROMs, DVDs, optical disc-like storage media similar thereto, and flexible disks, hard disks, magneto-optical disks, and magnetic tapes. The information storage medium storing the program may be a volatile memory storing the program. Such a storage medium may be said as a storage medium that can be read by a computer, etc. (computer-readable storage medium, etc.). For example, the above various functions can be provided by causing a computer, etc., to read and execute programs from these storage media.

While several non-limiting example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a”, “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

As described above, the present example can be used as a game program, game system, game apparatus, and game processing method in which, in a game using voxels, an object can be deformed, e.g., broken, with a high degree of freedom by the user's operation, and small broken pieces are prevented from being left due to the deformation such as destruction.

What is claimed is:

1. A non-transitory computer-readable storage medium having stored therein a game program that, when executed, causes one or more processors of an information processing apparatus to execute information processing comprising:
storing, in a storage medium, terrain volume data representing a terrain in a virtual space and holding voxel data indicating the presence of the terrain for each voxel included in a voxel space set in the virtual space;
when an event occurs with respect to the terrain, based on a player's operation input,
updating the voxel data such that the voxel data indicates the absence of the terrain for at least a portion of voxels included in a first range set based on a location of the occurrence of the event, with respect to the terrain volume data, and
when in a second range including at least the first range, present is a separate small region that includes contiguous voxels having voxel data indicating the presence of the terrain and has a size smaller than a reference, updating the voxel data of the voxels included in the small region such that the voxel data of the voxels included in the small region indicates the absence of the terrain; and
generating an image of the virtual space by rendering at least a polygon mesh representing a surface of the terrain, based on the terrain volume data.

2. The non-transitory computer-readable storage medium according to claim 1,
wherein the voxel data is a value indicating a degree to which a space defined by a voxel is occupied by the terrain, and
the information processing further comprises:
when the event occurs, updating the voxel data such that the voxel data indicates a decrease in the degree in the voxels included in the first range, and the absence of the terrain in at least a portion of the voxels included in the first range.

3. The non-transitory computer-readable storage medium according to claim 2, wherein
a region having contiguous voxels having voxel data indicating the presence of the terrain is determined to be the small region when the sum of values indicating the degrees in the voxels in the region is smaller than a threshold.

4. The non-transitory computer-readable storage medium according to claim 2, wherein
in the first range, a distance from a reference location set based on a location of the occurrence of the event in the virtual space is within a first distance, and
the information processing further comprises:
when the event occurs, updating the voxel data such that the voxel data indicates a decrease in the degree according to the distance from the reference location, and the absence of the terrain for voxels within a second distance from the reference location shorter than the first distance.

5. The non-transitory computer-readable storage medium according to claim 2, wherein
the voxel data further includes material data indicating a material for the terrain, and
the information processing further comprises:
when the event occurs, updating the voxel data of the voxels included in the first range such that the decrease in the degree is additionally based on the type of a material for the voxel indicated by the material data.

6. The non-transitory computer-readable storage medium according to claim 1, wherein
the information processing further comprises:
generating the polygon mesh according to an algorithm that determines a location of a vertex of a polygon between a voxel in which the terrain is absent and a voxel in which the terrain is present, based on the voxel data; and
recalculating vertices of the polygon mesh in a range including at least a voxel whose voxel data has been updated, based on the occurrence of the event.

7. The non-transitory computer-readable storage medium according to claim 1, wherein
the information processing further comprises:
causing a player character to perform an action of breaking the terrain, based on the player's operation input, and
in the event, the terrain is hit by the player character's breaking action.

8. The non-transitory computer-readable storage medium according to claim 1, wherein
the information processing further comprises:
updating the voxel data of the voxels included in the small region such that the voxel data indicates the absence of the terrain, when the small region is in the air in the virtual space.

9. A game system comprising:
a storage medium storing terrain volume data representing a terrain in a virtual space and holding voxel data indicating the presence of the terrain for each voxel included in a voxel space set in the virtual space; and
one or more processors that are configured to execute information processing comprising:
when an event occurs with respect to the terrain, based on a player's operation input,
updating the voxel data such that the voxel data indicates the absence of the terrain for at least a portion of voxels included in a first range set based on a location of the occurrence of the event, with respect to the terrain volume data, and
when in a second range including at least the first range, present is a separate small region that includes contiguous voxels having voxel data indicating the presence of the terrain and has a size smaller than a reference, updating the voxel data of the voxels included in the small region such that the voxel data of the voxels included in the small region indicates the absence of the terrain; and
generating an image of the virtual space by rendering at least a polygon mesh representing a surface of the terrain, based on the terrain volume data.

10. The game system according to claim 9, wherein
the voxel data is a value indicating a degree to which a space defined by a voxel is occupied by the terrain, and
the information processing further comprises:
when the event occurs, updating the voxel data such that the voxel data indicates a decrease in the degree in the voxels included in the first range, and the absence of the terrain in at least a portion of the voxels included in the first range.

11. The game system according to claim 10, wherein
a region having contiguous voxels having voxel data indicating the presence of the terrain is determined to be the small region when the sum of values indicating the degrees in the voxels in the region is smaller than a threshold.

12. The game system according to claim 10, wherein
in the first range, a distance from a reference location set based on a location of the occurrence of the event in the virtual space is within a first distance, and
the information processing further comprising:
when the event occurs, updating the voxel data such that the voxel data indicates a decrease in the degree according to the distance from the reference location, and the absence of the terrain for voxels within a second distance from the reference location shorter than the first distance.

13. The game system according to claim 10, wherein
the voxel data further includes material data indicating a material for the terrain, and
the information processing further comprises:
when the event occurs, updating the voxel data of the voxels included in the first range such that the decrease in the degree is additionally based on the type of a material for the voxel indicated by the material data.

14. The game system according to claim 9, wherein
the information processing further comprises:
generating the polygon mesh according to an algorithm that determines a location of a vertex of a polygon between a voxel in which the terrain is absent and a voxel in which the terrain is present, based on the voxel data; and
recalculating vertices of the polygon mesh in a range including at least a voxel whose voxel data has been updated based on the occurrence of the event.

15. The game system according to claim 9, wherein
the information processing further comprises:
causing a player character to perform an action of breaking the terrain, based on the player's operation input, and
in the event, the terrain is hit by the player character's breaking action.

16. The game system according to claim 9, wherein
the information processing further comprises:
updating the voxel data of the voxels included in the small region such that the voxel data indicates the absence of the terrain, when the small region is in the air in the virtual space.

17. A game apparatus comprising:
a storage medium storing terrain volume data representing a terrain in a virtual space and holding voxel data indicating the presence of the terrain for each voxel included in a voxel space set in the virtual space; and
one or more processors that are configured to execute information processing comprising:
when an event occurs with respect to the terrain, based on a player's operation input,
updating the voxel data such that the voxel data indicates the absence of the terrain for at least a portion of voxels included in a first range set based on a location of the occurrence of the event, with respect to the terrain volume data, and
when in a second range including at least the first range, present is a separate small region that includes contiguous voxels having voxel data indicating the presence of the terrain and has a size smaller than a reference, updating the voxel data of the voxels included in the small region such that the voxel data of the voxels included in the small region indicates the absence of the terrain; and
generating an image of the virtual space by rendering at least a polygon mesh representing a surface of the terrain, based on the terrain volume data.

18. The game apparatus according to claim 17, wherein
the voxel data is a value indicating a degree to which a space defined by a voxel is occupied by the terrain, and
the information processing further comprises:
when the event occurs, updating the voxel data such that the voxel data indicates a decrease in the degree in the voxels included in the first range, and the absence of the terrain in at least a portion of the voxels included in the first range.

19. The game apparatus according to claim 18, wherein
a region having contiguous voxels having voxel data indicating the presence of the terrain is determined to be the small region when the sum of values indicating the degrees in the voxels in the region is smaller than a threshold.

20. The game apparatus according to claim 18, wherein
in the first range, a distance from a reference location set based on a location of the occurrence of the event in the virtual space is within a first distance, and
the information processing further comprises:
when the event occurs, updating the voxel data such that the voxel data indicates a decrease in the degree according to the distance from the reference location, and the absence of the terrain for voxels within a second distance from the reference location shorter than the first distance.

21. The game apparatus according to claim 18, wherein
the voxel data further includes material data indicating a material for the terrain, and
the information processing further comprises:
when the event occurs, updating the voxel data of the voxels included in the first range such that the decrease in the degree is additionally based on the type of a material for the voxel indicated by the material data.

22. The game apparatus according to claim 17, wherein
the information processing further comprises:
generating the polygon mesh according to an algorithm that determines a location of a vertex of a polygon between a voxel in which the terrain is absent and a voxel in which the terrain is present, based on the voxel data; and
recalculating vertices of the polygon mesh in a range including at least a voxel whose voxel data has been updated, based on the occurrence of the event.

23. A game processing method performed on an information processing apparatus, the game processing method comprising:
storing terrain volume data representing a terrain in a virtual space and holding voxel data indicating the presence of the terrain for each voxel included in a voxel space set in the virtual space;
when an event occurs with respect to the terrain, based on a player's operation input,
updating the voxel data such that the voxel data indicates the absence of the terrain for at least a portion of voxels included in a first range set based on a location of the occurrence of the event, with respect to the terrain volume data, and
when in a second range including at least the first range, present is a separate small region that includes contiguous voxels having voxel data indicating the presence of the terrain and has a size smaller than a reference, updating the voxel data of the voxels included in the small region such that the voxel data of the voxels included in the small region indicates the absence of the terrain; and
generating an image of the virtual space by rendering at least a polygon mesh representing a surface of the terrain, based on the terrain volume data.

24. The game processing method according to claim 23, wherein
the voxel data is a value indicating a degree to which a space defined by a voxel is occupied by the terrain, and
the method causes the information processing apparatus to further execute:
when the event occurs, updating the voxel data such that the voxel data indicates a decrease in the degree in the voxels included in the first range, and the absence of the terrain in at least a portion of the voxels included in the first range.

25. The game processing method according to claim 24, wherein
a region having contiguous voxels having voxel data indicating the presence of the terrain is determined to be the small region when the sum of values indicating the degrees in the voxels in the region is smaller than a threshold.

26. The game processing method according to claim 24, wherein
in the first range, a distance from a reference location set based on a location of the occurrence of the event in the virtual space is within a first distance, and
the method causes the information processing apparatus to further execute:
when the event occurs, updating the voxel data such that the voxel data indicates a decrease in the degree according to the distance from the reference location, and the absence of the terrain for voxels within a second distance from the reference location shorter than the first distance.

27. The game processing method according to claim 24, wherein
the voxel data further includes material data indicating a material for the terrain, and
the method causes the information processing apparatus to further execute:
when the event occurs, updating the voxel data of the voxels included in the first range such that the decrease in the degree is additionally based on the type of a material for the voxel indicated by the material data.

28. The game processing method according to claim 23, wherein
the method causes the information processing apparatus to further execute:
generating the polygon mesh according to an algorithm that determines a location of a vertex of a polygon between a voxel in which the terrain is absent and a voxel in which the terrain is present, based on the voxel data; and
recalculating vertices of the polygon mesh in a range including at least a voxel whose voxel data has been updated, based on the occurrence of the event.
